(19) United States
(12) Patent Application Publication
(10) Pub. No.: US 2005/0160641 A1
(43) Pub. Date: Jul. 28, 2005

(54) Color sample fan deck with peel off feature

(76) Inventors: Hilda Camacho, Boca Raton, FL (US); Steve Daniels, Pembroke Pines, FL (US)

Correspondence Address: COLLEN IP, THE HOLYOKE MANHATTAN BUILDING, 80 SOUTH HIGHLAND AVENUE, OSSINING, NY, 10562, US

(21) Appl. No.: 11/042,595

(22) Filed: Jan. 24, 2005

Related U.S. Application Data
(60) Provisional application No. 60/538,609, filed on Jan. 23, 2004.

(51) Int. Cl. G09F 7/00

(52) U.S. Cl. 40/492

(57) ABSTRACT

A sample display primarily intended to display colors and textures. The sample display includes multiple cards removably affixed to sheets. Colors and textures are displayed on swatches affixed to the cards. Individual cards can readily be removed from the sheets. The sheets can be bound together such as in a typical fan display.

### CROSS REFERENCE TO RELATED APPLICATION

This application claims the benefit of U.S. Provisional Application No. 60/538,609, filed Jan. 23, 2004.

### BACKGROUND OF THE INVENTION

The present invention is directed to sample display devices and more particularly to a sample display in the form of a fan deck for displaying different colors and textures.

Suppliers of products of different colors typically provide their customers with samples of the colors and textures of the available products. Typically, the color samples are displayed on multiple sheets of heavy paper sometimes bound at a single point by a bolt or similar device. This arrangement allows for the color samples to pivot on the point of attachment and enables them to be spread out much like a fan. The standard fan deck would have one sample of the color and texture with some indicia to identify the color and texture. A customer that would like to take a sample of a specific color has to take the entire fan deck, or tear off a desired sample color, thereby rendering the remaining portion of the color sample fan deck incomplete.

### BRIEF DESCRIPTION OF THE DRAWINGS

FIG. 1 illustrates the fan deck arrangement of the present invention.

FIG. 2 illustrates the color sample sheet of the present invention.

FIG. 3 illustrates a cross section of a color sample sheet.

FIG. 4 illustrates a single color card of the present invention.

### DETAILED DESCRIPTION OF THE PREFERRED EMBODIMENT

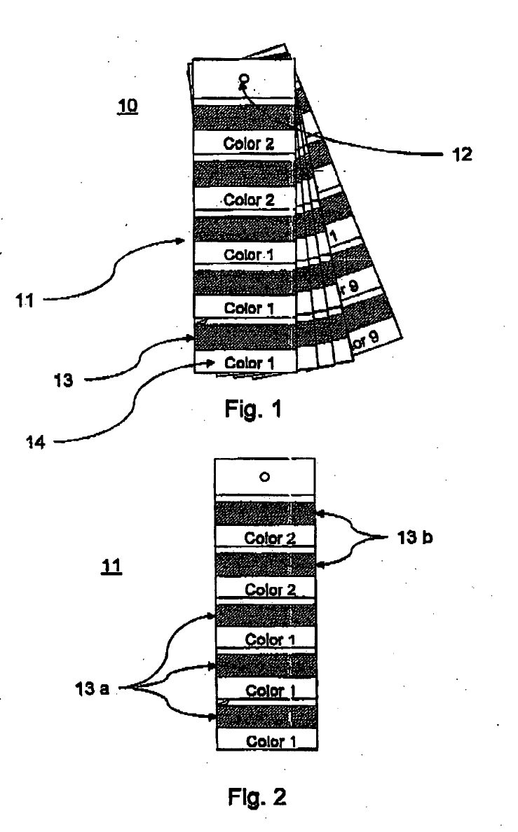

FIG. 1 illustrates a color sample fan deck (10) of the present invention. A fan deck is made of a plurality of sheets (11) secured about a pivot point (12) with the use of a bolt or similar device. Each sheet (11) includes a number of color swatches (13) illustrating a color and texture and a name or reference (14) to each color and texture (13).

In the fan deck (10) of the present invention, multiple swatches (13) of the same color and texture would be included in the fan deck. The multiple swatches (13) of the same color and texture may be included in a single sheet (11) or may be disposed in multiple sheets (11).

FIG. 2 illustrates the single color sample sheet (11) with three swatches (13a) of color 1, and two swatches (13b) of color 2. It should be readily apparent to one of ordinary skill in the art that the color sample sheet (11) could be arranged with any number of color swatches (13) of the same color.

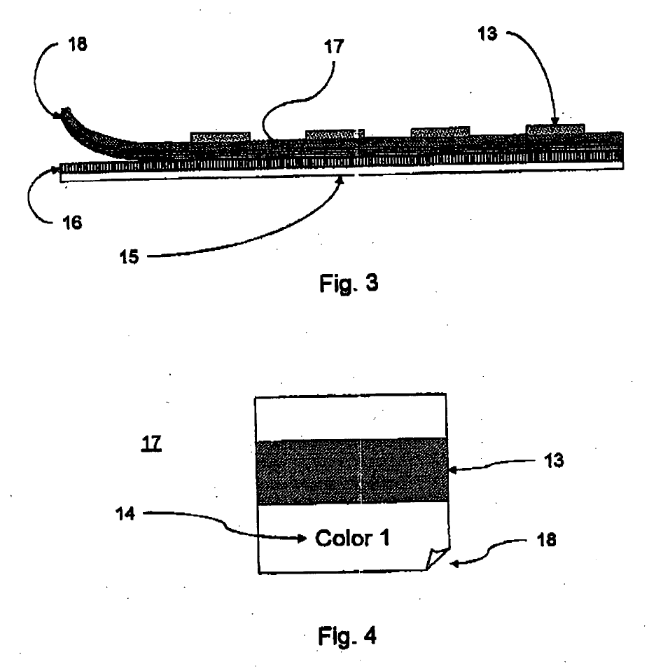

FIG. 3 illustrates a cross section of a sheet (11). The sheet (11) is made of a substrate (15), typically made of paper or similar material. A release liner (16) made of a silicone or similar type material is deposited on substrate (15). Each color swatch (13) and the name or reference (14) is printed on one side of a card (17). Each card (17) has a transfer adhesive (18) applied to the side opposite to the side on which the color swatch (13) has been printed. A plurality of cards (17) are deposited on each substrate (15) thereby creating a sheet (11) with multiple color swatches (13).

FIG. 4 illustrates a single card (17) having a single color swatch (13) and a single color reference (14).

The novel construction of the color sample fan deck (10) of the present invention enables a customer to peel off a card (17) bearing only one color swatch (13), and name or reference (14) and paste it on an architectural drawing for easy reference. Because the fan deck (10) carries more than one swatch (13) of the same color, the fan deck can be used again even if a customer removes a card (17) with a desired color swatch (13).

A color sample fan deck (10) can be used for paint samples, grout color samples, and similar displays.

The above description and accompanying figures are presented as examples of the present invention. The scope of the present invention is not limited by the exemplary embodiment. It is recognized that departures from the disclosed embodiment may be within the scope of the invention and obvious modifications will occur to a person skilled in the art. For example, other features besides colors and textures such as fabric, tile and wood samples, are within the scope of the invention.

1. A sample display comprising:
a sheet;
a card affixed to the sheet;
a swatch display affixed to the card; and
the card being readily removable

2. A sample display according to claim 1, in which the sheet is made of a substrate with a release liner affixed to the sheet and a minimum of one card applied to the release liner on the sheet.

3. A sample display according to claim 2, wherein multiple sheets are bound together.

4. A sample display according to claim 2, wherein the card includes a name or reference indicator for the displayed swatch.

5. A sample display according to claim 2, wherein multiple cards are included on a sheet.

6. A sample display according to claim 5, wherein all the cards on the sheet display the same color.

7. A sample display according to claim 2, wherein the swatches on the cards display colors.

8. A sample display according to claim 7, wherein the swatches also display the texture.

9. A sample display comprising:
means for affixing a minimum of one card to a sheet;
means for readily removing the card from the sheet;
means for affixing a swatch to the card; and
means for displaying colors on the swatch.

10. A sample display according to claim 9, wherein multiple cards are included on a sheet.

11. A sample display according to claim 9, wherein multiple sheets are bound together.

12. A sample display according to claim 9, wherein the card includes a name or reference indicator for the displayed swatch.

13. A sample display according to claim 9, further comprising a means for displaying texture.

14. A sample display according to claim 13, wherein all the cards on the sheet display the same color and texture.
